(19) United States
(12) Patent Application Publication
(10) Pub. No.: US 2026/0197144 A1
(43) Pub. Date: Jul. 9, 2026

(54) INFORMATION SIZES FOR PROBABILISTIC SHAPING

(71) Applicant: QUALCOMM Incorporated, San Diego, CA (US)

(72) Inventors: Wei YANG, San Diego, CA (US); Gabi SARKIS, San Diego, CA (US); Hobin KIM, San Diego, CA (US); Jing JIANG, San Diego, CA (US)

(21) Appl. No.: 19/013,780

(22) Filed: Jan. 8, 2025

(51) Int. Cl. H04L 5/00; H04W 72/1273

(52) U.S. Cl. CPC H04L 5/0094; H04W 72/1273

(57) ABSTRACT

Methods, systems, and devices for wireless communications are described. A wireless device (or apparatus at the device), such as a transmitting device, may communicate scheduling information for an encoded message, including downlink or uplink scheduling information. The wireless device may also transmit or receive an encoded message in accordance with the scheduling information. In some examples, the encoded message may include a set of multiple bits that are generated in accordance with performance of a probabilistic amplitude shaping (PAS) operation for a set of code blocks (CBs) of a transport block (TB). Each CB of the set of CBs may include a quantity of bits that is a multiple of eight bits. In some examples, the quantity of bits of a CB may be associated with a shaping parameter and a floor function. Further, the PAS operation may be performed per CB of the set of CBs.

### FIELD OF TECHNOLOGY

The following relates to wireless communications, including information sizes for probabilistic shaping.

### BACKGROUND

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless systems, data may be modulated by a transmitting device for transmission to a receiving device by shaping the data into a constellation of modulated symbols.

### SUMMARY

The systems, methods, and devices of this disclosure each have several innovative aspects, no single one of which is solely responsible for the desirable attributes disclosed herein. The described techniques relate to improved methods, systems, devices, and apparatuses that support probabilistic shaping and channel coding for wireless signals. For example, the described techniques provide for utilizing transport block (TB) sizes having multiples of eight bits and for code block (CB) sizes having multiples of eight bits, and ensuring shaped information bits per CB match modulation symbols. A wireless device (or apparatus at the device), such as a transmitting device, may communicate scheduling information for an encoded message, including downlink or uplink scheduling information. The wireless device may also transmit or receive an encoded message in accordance with the scheduling information. In some examples, the encoded message may include a set of multiple bits that are generated in accordance with performance of a probabilistic amplitude shaping (PAS) operation for a set of CBs of a TB, where the TB and one or more CBs may include quantities of bits that are a multiple of eight bits. In some examples, the quantity of bits of a CB may be associated with application of a floor function to an initial CB size that is associated with a shaping parameter. Further, the PAS operation may be performed per CB of the set of CBs.

One innovative aspect of the subject matter described in this disclosure can be implemented in an apparatus for wireless communication at a wireless communication device. The apparatus may include a processing system that includes processor circuitry and memory circuitry that stores code. The processing system may be configured to cause the apparatus to communicate scheduling information for an encoded message and transmit the encoded message in accordance with the scheduling information, the encoded message including a set of multiple bits that are generated in accordance with performance of a PAS operation for a set of CBs of a TB, each CB of the set of CBs including a quantity of bits that is a multiple of eight bits.

In some examples, the processing system may be configured to cause the apparatus to obtain a shaping parameter, the quantity of bits of a CB of the set of CBs being in accordance with application of a floor function to an initial CB size that may be associated with the shaping parameter.

In some examples, the shaping parameter includes a first shaping parameter that may be in accordance with an estimated quantity of bits resulting from application of the floor function to a second initial CB size associated with a second shaping parameter.

In some examples, to communicate the scheduling information, the processing system is configured to cause the apparatus to communicate the shaping parameter.

In some examples, the PAS operation may be performed per CB of the set of CBs of the TB.

In some examples, a CB of the set of CBs includes a first quantity of unshaped bits that may be a multiple of eight bits and a second quantity of unshaped bits that may be a multiple of eight bits and the first quantity of unshaped bits may be input into the PAS operation and the second quantity of unshaped bits remain unshaped.

Another innovative aspect of the subject matter described in this disclosure can be implemented in a method for wireless communications by a wireless communication device. The method may include communicating scheduling information for an encoded message and transmitting the encoded message in accordance with the scheduling information, the encoded message including a set of multiple bits that are generated in accordance with performance of a PAS operation for a set of CBs of a TB, each CB of the set of CBs including a quantity of bits that is a multiple of eight bits.

Another innovative aspect of the subject matter described in this disclosure can be implemented in a non-transitory computer-readable medium storing code for wireless communications. The code may include instructions executable by one or more processors to communicate scheduling information for an encoded message and transmit the encoded message in accordance with the scheduling information, the encoded message including a set of multiple bits that are generated in accordance with performance of a PAS operation for a set of CBs of a TB, each CB of the set of CBs including a quantity of bits that is a multiple of eight bits.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports information sizes for probabilistic shaping used in code blocks (CBs) and transport blocks (TBs) for encoded messages in accordance with one or more aspects of the present disclosure.

FIGS. 2A, 2B, and 2C show examples of a wireless communications system including a network entity in communication with a user equipment (UE), a transmission flow for wireless devices, and a reception flow for wireless devices that support utilizing information sizes for probabilistic shaping used in CBs and TBs for encoded messages in accordance with one or more aspects of the present disclosure.

FIG. 3 shows an example of a transmission scheme for communications between wireless devices that may implement information sizes for probabilistic shaping used in CBs and TBs for encoded messages in accordance with one or more aspects of the present disclosure.

FIG. 4 shows an example of a modulation constellation with PAS that supports information sizes for probabilistic shaping used in CBs and TBs for encoded messages in accordance with one or more aspects of the present disclosure.

FIG. 5 shows an example of a process flow that supports information sizes for probabilistic shaping used in CBs and TBs for encoded messages in accordance with one or more aspects of the present disclosure.

FIGS. 6 and 7 show block diagrams of devices that support information sizes for probabilistic shaping used in CBs and TBs for encoded messages in accordance with one or more aspects of the present disclosure.

FIG. 8 shows a block diagram of a communications manager of a wireless device that supports information sizes for probabilistic shaping used in CBs and TBs for encoded messages in accordance with one or more aspects of the present disclosure.

FIG. 9 shows a diagram of a system including a device that supports information sizes for probabilistic shaping used in CBs and TBs for encoded messages in accordance with one or more aspects of the present disclosure.

FIG. 10 shows a diagram of a system including a device that supports information sizes for probabilistic shaping used in CBs and TBs for encoded messages in accordance with one or more aspects of the present disclosure.

FIGS. 11 and 12 show flowcharts showing methods that support information sizes for probabilistic shaping in accordance with one or more aspects of the present disclosure.

### DETAILED DESCRIPTION

Some wireless communications systems may utilize higher order modulation to increase spectral efficiency for wireless transmissions. In some cases, a distribution of modulated symbols may be shaped such that different symbols may have different probabilities of usage, where such a distribution may be referred to as a non-uniform distribution of symbols. For example, the distribution of symbols may be shaped using one or more probabilistic shaping techniques. Probabilistic shaping may be a technique used to increase spectral efficiency of the coded modulation, and may generate non-uniformly distributed coded modulation symbols, or non-uniformly distributed constellations. In some examples, non-uniformly distributed symbols may have a higher capacity and may result in higher transmission capacities, higher spectral efficiencies, or generally higher communication quality than uniform symbol distributions.

An example of a probabilistic shaping framework may be probabilistic amplitude shaping (PAS) (such as distribution matching). PAS may shape an amplitude of a constellation of modulated symbols (such as the amplitude may be non-uniform), while leaving the sign of the constellation uniformly distributed. In some examples, PAS may be performed prior to channel coding of information bits. PAS may also be used in conjunction with transport block (TB) (such as a physical layer packet) and code block (CB) (such as a sub-packet for coding) generation and transmission. For example, PAS may involve per CB shaping. However, in some cases, a size of a TB or CB before shaping may be variable or may involve a quantity of bits that may be a multiple other than eight (such as non-byte-aligned bits), and so there may be opportunities for improving efficiency in communications and calculation by changing a TB size or CB size.

The described techniques may provide for implementing a size of a TB or CB as a multiple of eight bits and ensuring shaped information bits per CB match modulation symbols. For example, a wireless device, such as a transmitting device, may configure a TB size to be a multiple of eight bits before shaping. In some examples, the wireless device may, after TB segmentation, configure a CB size for a set of CBs to be a multiple of eight bits before shaping (such as before being input to a PAS shaper). In some examples, the wireless device may configure both bits to be shaped, and bits to remain unshaped, separately as multiples of eight for each CB. In some examples, a quantity of bits per CB may be more than a previous quantity before shaping. For example, a quantity of bits for a CB may be determined using a shaping parameter, and may be a multiple other than eight bits. The quantity of bits may in some examples be equal to a quantity of amplitude bits for a CB. For a CB size before shaping, some devices may further truncate bits to multiples of eight using a floor function based on the shaping parameter, and may modify (such as increase) the shaping parameter in some examples to compensate for the truncation.

Particular aspects of the subject matter described in this disclosure can be implemented to realize one or more of the following potential advantages. In some examples, using eight bit multiples for TB sizes and CB sizes, as well as for shaped and unshaped bits, may increase an efficiency in memory operations performed before shaping by simplifying information bit storage to byte increments. Truncating bits using a floor function may further improve memory operation efficiency, while modifying (such as increasing) an initial shaping parameter may increase spectral efficiency and counteract a rate loss due to truncation.

Aspects of the disclosure are initially described in the context of wireless communications systems. Aspects of the disclosure are further illustrated by and described with reference to wireless communications systems and transmission schemes that relate to information sizes for probabilistic shaping. Aspects of the disclosure are further illustrated by and described with reference to apparatus diagrams, system diagrams, and flowcharts that relate to information sizes for probabilistic shaping.

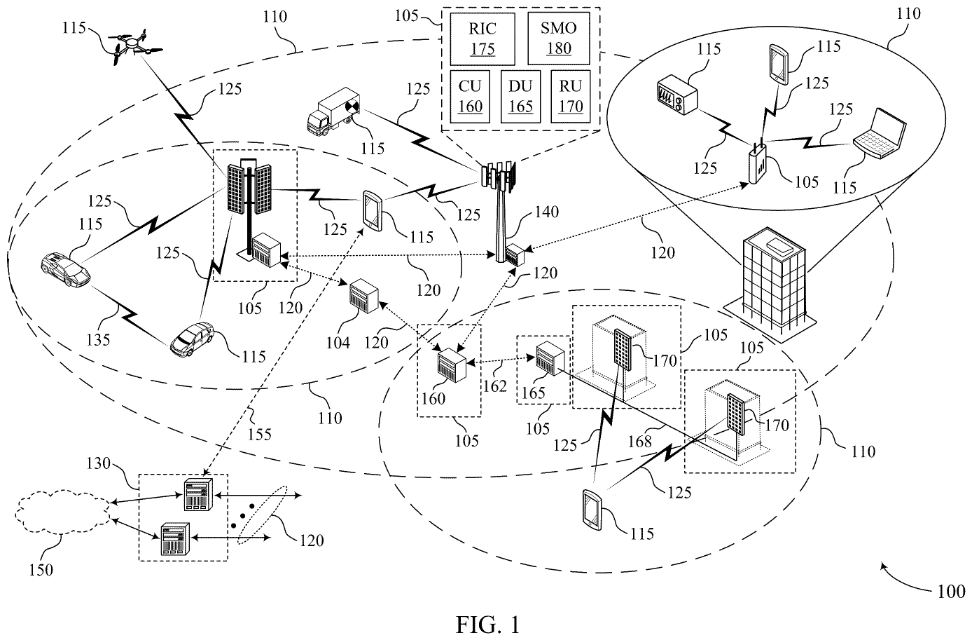

FIG. 1 shows an example of a wireless communications system 100 that supports information sizes for probabilistic shaping used in CBs and TBs for encoded messages in accordance with one or more aspects of the present disclosure. The wireless communications system 100 may include one or more devices, such as one or more network devices (for example, network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (for example, a radio frequency (RF) access link). For example, a network entity 105 may support a coverage area 110 (for example, a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (for example, other wireless communication devices, including UEs 115 or network entities 105), as shown in FIG. 1.

As described herein, a node of the wireless communications system 100, which may be referred to as a network node, or a wireless node, may be a network entity 105 (for example, any network entity described herein), a UE 115 (for example, any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (for example, in accordance with an S1, N2, N3, or other interface protocol). In some examples, network entities 105 may communicate with one another via backhaul communication link(s) 120 (for example, in accordance with an X2, Xn, or other interface protocol) either directly (for example, directly between network entities 105) or indirectly (for example, via the core network 130). In some examples, network entities 105 may communicate with one another via a midhaul communication link 162 (for example, in accordance with a midhaul interface protocol) or a fronthaul communication link 168 (for example, in accordance with a fronthaul interface protocol), or any combination thereof. The backhaul communication link(s) 120, midhaul communication links 162, or fronthaul communication links 168 may be or include one or more wired links (for example, an electrical link, an optical fiber link) or one or more wireless links (for example, a radio link, a wireless optical link), among other examples or various combinations thereof. A UE 115 may communicate with the core network 130 via a communication link 155.

One or more of the network entities 105 or network equipment described herein may include or may be referred to as a base station 140 (for example, a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (for example, a base station 140) may be implemented in an aggregated (for example, monolithic, standalone) base station architecture, which may be configured to utilize a protocol stack that is physically or logically integrated within one network entity (for example, a network entity 105 or a single RAN node, such as a base station 140).

In some examples, a network entity 105 may be implemented in a disaggregated architecture (for example, a disaggregated base station architecture, a disaggregated RAN architecture), which may be configured to utilize a protocol stack that is physically or logically distributed among multiple network entities (for example, network entities 105), such as an integrated access and backhaul (IAB) network, an open RAN (O-RAN) (for example, a network configuration sponsored by the O-RAN Alliance), or a virtualized RAN (vRAN) (for example, a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (for example, a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (for example, separate physical locations). In some examples, one or more of the network entities 105 of a disaggregated RAN architecture may be implemented as virtual units (for example, a virtual CU (VCU), a virtual DU (VDU), a virtual RU (VRU)).

The split of functionality between a CU 160, a DU 165, and an RU 170 is flexible and may support different functionalities depending on which functions (for example, network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (for example, layer 3 (L3), layer 2 (L2)) functionality and signaling (for example, Radio Resource Control (RRC), service data adaptation protocol (SDAP), Packet Data Convergence Protocol (PDCP)). The CU 160 (for example, one or more CUs) may be connected to a DU 165 (for example, one or more DUs) or an RU 170 (for example, one or more RUs), or some combination thereof, and the DUs 165, RUs 170, or both may host lower protocol layers, such as layer 1 (L1) (for example, physical (PHY) layer) or L2 (for example, radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (for example, via one or multiple different RUs, such as an RU 170). In some cases, a functional split between a CU 160 and a DU 165 or between a DU 165 and an RU 170 may be within a protocol layer (for example, some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (for example, F1, F1-c, F1-u), and a DU 165 may be connected to an RU 170 via a fronthaul communication link 168 (for example, open fronthaul (FH) interface). In some examples, a midhaul communication link 162 or a fronthaul communication link 168 may be implemented in accordance with an interface (for example, a channel) between layers of a protocol stack supported by respective network entities (for example, one or more of the network entities 105) that are in communication via such communication links.

In some wireless communications systems (for example, the wireless communications system 100), infrastructure and spectral resources for radio access may support wireless backhaul link capabilities to supplement wired backhaul connections, providing an IAB network architecture (for example, to a core network 130). In some cases, in an IAB network, one or more of the network entities 105 (for example, network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (for example, IAB donors) may be in communication with one or more additional devices (for example, IAB node(s) 104) via supported access and backhaul links (for example, backhaul communication link(s) 120). IAB node(s) 104 may include an IAB mobile termination (IAB-MT) controlled (for example, scheduled) by one or more DUs (for example, DUs 165) of a coupled IAB donor. An IAB-MT may be equipped with an independent set of antennas for relay of communications with UEs 115 or may share the same antennas (for example, of an RU 170) of IAB node(s) 104 used for access via the DU 165 of the IAB node(s) 104 (for example, referred to as virtual IAB-MT (vIAB-MT)). In some examples, the IAB node(s) 104 may include one or more DUs (for example, DUs 165) that support communication links with additional entities (for example, IAB node(s) 104, UEs 115) within the relay chain or configuration of the access network (for example, downstream). In such cases, one or more components of the disaggregated RAN architecture (for example, the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support information sizes for probabilistic shaping as described herein. For example, some operations described as being performed by a UE 115 or a network entity 105 (for example, a base station 140) may additionally, or alternatively, be performed by one or more components of the disaggregated RAN architecture (for example, components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (for example, one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (for example, a bandwidth part (BWP)) that is operated according to one or more PHY layer channels for a given RAT (for example, LTE, LTE-A, LTE-A Pro, NR). Each PHY layer channel may carry acquisition signaling (for example, synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (for example, entity, sub-entity) of a network entity 105. For example, the terms “transmitting,” “receiving,” or “communicating,” when referring to a network entity 105, may refer to any portion of a network entity 105 (for example, a base station 140, a CU 160, a DU 165, a RU 170) of a RAN communicating with another device (for example, directly or via one or more other network entities, such as one or more of the network entities 105).

The communication link(s) 125 of the wireless communications system 100 may include downlink transmissions (for example, forward link transmissions) from a network entity 105 to a UE 115, uplink transmissions (for example, return link transmissions) from a UE 115 to a network entity 105, or both, among other configurations of transmissions. Carriers may carry downlink or uplink communications (for example, in an FDD mode) or may be configured to carry downlink and uplink communications (for example, in a TDD mode). For example, a UE may act as a transmitting device and a network entity may act as a receiving device in uplink communications, a network entity may act as a transmitting device and a UE may act as a receiving device in downlink communications, or a UE may act as a transmitting device or a receiving device in sidelink communications.

Signal waveforms transmitted via a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (for example, a duration of one modulation symbol) and one subcarrier, in which case the symbol period and subcarrier spacing may be inversely related. The quantity of bits carried by each resource element may depend on the modulation scheme (for example, the order of the modulation scheme, the coding rate of the modulation scheme, or both), such that a relatively higher quantity of resource elements (for example, in a transmission duration) and a relatively higher order of a modulation scheme may correspond to a relatively higher rate of communication. A wireless communications resource may refer to a combination of an RF spectrum resource, a time resource, and a spatial resource (for example, a spatial layer, a beam), and the use of multiple spatial resources may increase the data rate or data integrity for communications with a UE 115. Modulation may in some cases involve Quadrature Amplitude Modulation (QAM), among other modulation schemes.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (for example, 10 milliseconds (ms)). Each radio frame may be identified by a system frame number (SFN) (for example, ranging from 0 to 1023).

Each frame may include multiple consecutively-numbered subframes or slots, and each subframe or slot may have the same duration. In some examples, a frame may be divided (for example, in the time domain) into subframes, and each subframe may be further divided into a quantity of slots. Alternatively, each frame may include a variable quantity of slots, and the quantity of slots may depend on subcarrier spacing. Each slot may include a quantity of symbol periods (for example, depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (for example, N_{f}) sampling periods. The duration of a symbol period may depend on the subcarrier spacing or frequency band of operation.

A subframe, a slot, a mini-slot, or a symbol may be the smallest scheduling unit (for example, in the time domain) of the wireless communications system 100 and may be referred to as a transmission time interval (TTI). In some examples, the TTI duration (for example, a quantity of symbol periods in a TTI) may be variable. Additionally, or alternatively, the smallest scheduling unit of the wireless communications system 100 may be dynamically selected (for example, in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a set of symbol periods and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (for example, control channel elements (CCEs)) associated with encoded information for a control information format having a given payload size. Search space sets may include common search space sets configured for sending control information to UEs 115 (for example, one or more UEs) or may include UE-specific search space sets for sending control information to a UE 115 (for example, a specific UE).

In some examples, a network entity 105 (for example, a base station 140, an RU 170) may be movable and therefore provide communication coverage for a moving coverage area, such as the coverage area 110. In some examples, coverage areas 110 (for example, different coverage areas) associated with different technologies may overlap, but the coverage areas 110 (for example, different coverage areas) may be supported by the same network entity (for example, a network entity 105). In some other examples, overlapping coverage areas, such as a coverage area 110, associated with different technologies may be supported by different network entities (for example, the network entities 105). The wireless communications system 100 may include, for example, a heterogeneous network in which different types of the network entities 105 support communications for coverage areas 110 (for example, different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (for example, one or more of the UEs 115) via a device-to-device (D2D) communication link, such as a D2D communication link 135 (for example, in accordance with a peer-to-peer (P2P), D2D, or sidelink protocol). In some examples, one or more UEs 115 of a group that are performing D2D communications may be within the coverage area 110 of a network entity 105 (for example, a base station 140, an RU 170), which may support aspects of such D2D communications being configured by (for example, scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (for example, base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (for example, less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (for example, LAA). Operations using unlicensed spectrum may include downlink transmissions, uplink transmissions, P2P transmissions, or D2D transmissions, among other examples.

A network entity 105 (for example, a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (for example, a network entity 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (for example, the communication link(s) 125, a D2D communication link 135). HARQ may include a combination of error detection (for example, using a cyclic redundancy check (CRC)), forward error correction (FEC), such as FEC used in transmit data flows, and retransmission (for example, automatic repeat request (ARQ)). HARQ may improve throughput at the MAC layer in relatively poor radio conditions (for example, low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A wireless device (such as a network entity 105 or a UE 115), such as a transmitting device, may shape a set of information bits (such as including data bits and parity bits) using a set of masking bits. For example, a transmitting device may encode, shape, modulate, and transmit information bits to a receiving device (such as a UE 115 or a network entity 105), and the receiving device may demodulate, deshape, and decode the received information bits. In some examples, a wireless device may configure a TB size to be a multiple of eight bits before shaping. The wireless device may also, after TB segmentation, configure a CB size for a set of CBs to be a multiple of eight bits before shaping (such as before being input to a PAS shaper). In some examples, the wireless device may configure both bits to be shaped, and bits to remain unshaped, separately as multiples of eight for each CB. In some examples, a quantity of bits per CB may be more than a previous quantity before shaping. For example, a quantity of bits for a CB may be determined using a shaping parameter, and may be a multiple other than eight bits (such as may be equal to a quantity of amplitude bits for a CB). For a CB size before shaping, some devices may further truncate bits to multiples of eight bits using a floor function based on the shaping parameter, and may in some examples modify (such as increase) the shaping parameter to compensate for the truncation.

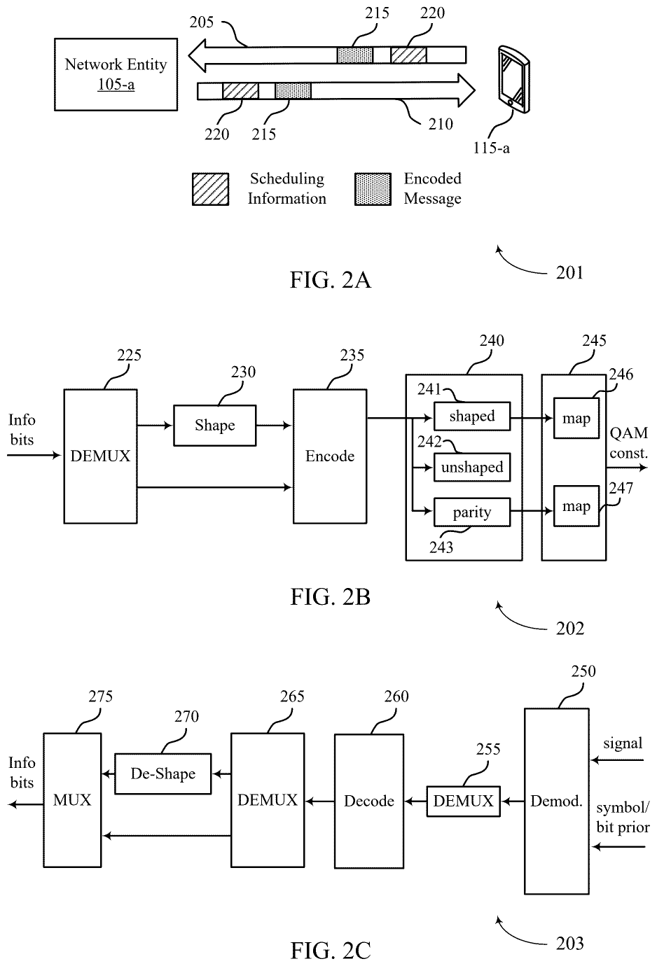

FIGS. 2A, 2B, and 2C show examples of a wireless communications system 201, a transmission flow 202, and a reception flow 203 that support utilizing information sizes for probabilistic shaping used in CBs and TBs for encoded messages in accordance with one or more aspects of the present disclosure. For example, the wireless communications system 201 may include a network entity 105-a and a UE 115-a, which may be examples of the corresponding devices described herein with reference to FIG. 1. The transmission flow 202 and the reception flow 203 may also show examples of flows for data transmission and reception between UEs 115 and/or network entities 105.

In the example of FIG. 2A, the network entity 105-a and the UE 115-a may communicate with each other in either the uplink or the downlink, where the UE 115-a may transmit in the uplink and the network entity 105-a may transmit in the downlink. In some cases, the UE 115-a may additionally, or alternatively, communicate with another UE 115 in the sidelink. A device transmitting a signal (such as in the uplink, downlink, or sidelink) may be referred to as a transmitting device, and a device receiving the transmitted signal (such as in the uplink, downlink, or sidelink) may be referred to as a receiving device.

Generally, the wireless communications system 201 illustrates an example of the network entity 105-a and the UE 115-a communicating via an uplink channel 205 or a downlink channel 210, while the UE 115-a may additionally, or alternatively, communicate with another UE 115 or wireless device via a sidelink channel. For example, the network entity 105-a, the UE 115-a, or both, may transmit a signal modulated to represent an encoded message 215. As such, the encoded message 215 (such as the modulated signal representative of bits of the encoded message) may be communicated between the network entity 105-a and the UE 115-a via the uplink channel 205 or the downlink channel 210. For example, the encoded message 215 may be transmitted via a distribution of modulated symbols, where each symbol in the distribution may represent one or more bits.

Some wireless communications systems (such as cellular systems, Wi-Fi systems) may utilize modulation, which may in some examples involve probabilistic shaping. In some examples, probabilistic shaping may involve generating non-uniformly distributed (such as QAM) constellations to maximize information communicated through a channel (such as based on input and output). For example, a Maxwell-Boltzmann distribution may maximize source entropy for a given average power, where inner constellations may be used with a higher probability.

In some examples, probabilistic shaping may differ from having an equal probability for each point in a constellation with relatively low energy or relatively low power for inner constellation points and relatively high energy or relatively high power for outer constellation points. For example, probabilistic shaping may involve unequal probability, with inner, low energy or low power constellation points sent more frequently (with a higher probability) than outer, high energy or high power constellation points that are sent less frequently (with a lower probability). In some examples, the Maxwell-Boltzmann distribution may be represented by p(x)~e^{-v|x|}^{²}, where p(x) may be a probability for a particular point x, and |x|² may represent a power of a transmission, whereas v may be a shaping parameter. Techniques for probabilistic shaping may include PAS, which may shape the amplitude of the constellation, but which may leave a sign of the constellation uniformly distributed. Other techniques may include constant-composition distribution matching (CCDM), energy-based shaping, Huffman based shaping, polar-code based shaping, among other techniques.

In the example of FIG. 2B, in the transmission flow 202, a transmitting device may receive information bits at a demultiplexer at 225, and may output one or more bits to be shaped to a shaper at 230, and may transmit the shaped bits and (in some examples) one or more bits to remain unshaped to a component for encoding or error detection code generation (such as systematic FEC) at 235. The resulting bits may be output to one or more devices for bit-to-constellation mapping at 240 for mapping shaped systematic bits at 241, mapping unshaped systematic bits at 242, and mapping parity bits at 243, and the transmitting device may output such bits to QAM modulation at 245 to map the shaped systematic bits to one or more amplitudes at 246 and to map the unshaped systematic bits and the parity bits to a sign at 247. The transmitting device may output a corresponding message including the mapped bits (for example, an encoded message 215) in accordance with one or more non-uniformly distributed QAM constellations.

In the example of FIG. 2C, in the reception flow 203, a receiving device at 250 may demodulate a received signal and symbol or bit prior (for example, corresponding to a transmitted encoded message 215), output demodulated signal(s) to a demultiplexer at 255 which may output to a decoder at 260 and subsequently to a demultiplexer at 265 to output bits for de-shaping at 270. The receiving device may combine the deshaped bits and other bits (such as bits that were not shaped in the transmission) using a multiplexer at 275 to output a final decoded output of information bits. In some examples, the receiving device may determine which bits are shaped based on one or more fixed rules (such as based on an order of bits).

In some examples, a transmitting device data flow may involve TB generation, TB size determination, generating and adding TB CRC bits, TB to CB segmentation, generating and adding CB CRC bits, encoding using FEC, such as Low-density parity-check (LDPC) encoding, rate matching, bit interleaving (such as systematic bit priority mapping (SBPM) interleaving via an SBPM interleaver), CB concatenation, among other operations, before transmitting a modulated encoded message. Some systems may also perform CB shaping, including per CB shaping, which may include a CB size prior to shaping (such as for an information CB size before shaping) and a CB size after shaping and prior to encoding that may be different (for example, a larger coding CB size after shaping). Encoding may also involve the per CB shaping (such as LDPC encoding involving the shaped CB bits). For example, PAS may be performed prior to channel coding of information bits, and may be used in conjunction with TB and CB generation and transmission and may involve shaping bits of each CB separately. However, in some examples, a size of a TB or CB before shaping may be variable or have a quantity of bits other than eight bits (such as non-byte-aligned bits), and so there may be opportunities for improving efficiency in communications and calculation by changing a TB size or CB size.

As described herein, within a PAS system, various techniques may be used to determine a quantity of information bits prior to shaping and after shaping. For example, a wireless device, such as a transmitting device (such as the UE 115-a transmitting in the uplink or the network entity 105-a transmitting in the downlink) may communicate scheduling information 220, and may transmit an encoded message 215 in accordance with the scheduling information. The encoded message 215 may include a set of multiple bits that are generated in accordance with performance of a PAS operation for a set of CBs of a TB. In some examples, each CB of the set of CBs may include a quantity of bits that is a multiple of eight bits as described herein. In some examples, using eight bit multiples for TB sizes and CB sizes may increase an efficiency in memory operations performed before shaping by simplifying information bit storage to byte increments. Additionally, or alternatively, the wireless device may obtain a shaping parameter via the scheduling information 220 or one or more stored parameters, where a quantity of bits of a CB of the set of CBs may be in accordance with application of a floor function to an initial CB size that is associated with the shaping parameter.

In some cases, converting a TB or CB size into a TB or CB size that is a multiple of eight bits may involve padding. In some cases, padding may include first computing a raw TB size,

$${N}_{info}^{′} .$$

If the TB size is greater than a threshold (such as a threshold multiple of eight bits), the raw TB size (TBS) may be converted to a integer quantity that is multiple of eight bits so that

$$TBS = 8 * C ⌈ \frac{{N}_{info}^{′} + 24}{8 * C} ⌉ - 24 ,$$

where

$$C = ⌈ \frac{{N}_{info}^{′} + 24}{threshold} ⌉ .$$

In some cases, C may be a quantity of CBs (for example, determined at an earlier time), and 24 may correspond to a 24 bit CRC applied to each CRC. In some examples, the threshold may be 8424. Additionally, or alternatively, other values for C, and for CRC bits, may be implemented. Additionally, or alternatively, other values for the threshold may be implemented. Otherwise, the TB size may be calculated so that

$$TBS = 8 * ⌈ \frac{{N}_{info}^{′} + 24}{8 * C} ⌉ - 24.$$

In some examples, the UE 115-a may receive scheduling information 220 for an uplink transmission, where an encoded message 215 that is transmitted in accordance with the scheduling information 220 may be an uplink transmission transmitted by the UE 115-a. In such an example, in some examples, the network entity 105-a may output (such as transmit directly or transmit via one or more components) the scheduling information to the UE 115-a for the uplink transmission, obtain (such as receiver directly or receive via one or more components) the uplink transmission, or both. Additionally, or alternatively, the network entity 105-a may output scheduling information 220 for a downlink transmission, where an encoded message 215 that is output in accordance with the scheduling information may be the downlink transmission. In such an example, in some examples, the UE 115-a may receive the scheduling information 220 for the downlink transmission, receive the downlink transmission, or both.

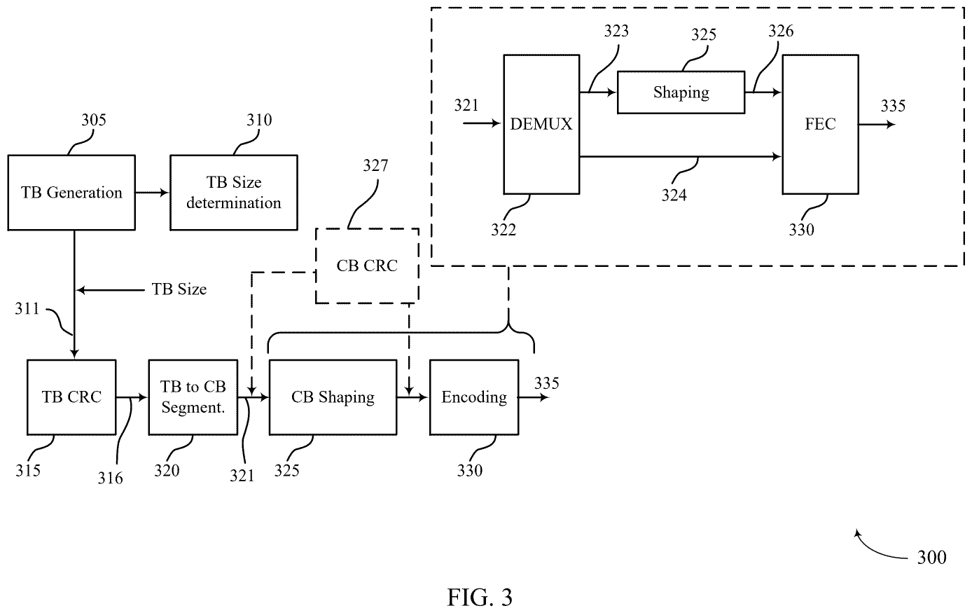

FIG. 3 shows an example of a transmission scheme 300 for communications between wireless devices that may implement information sizes for probabilistic shaping used in CBs and TBs for encoded messages in accordance with one or more aspects of the present disclosure. FIG. 3 may include one or more of the features described with reference to FIGS. 2A-2C. For example, FIG. 3 may illustrate one or more techniques for the processing of information bits for shaping, encoding, and modulating information bits (such as data and associated parity bits) for transmission, such as using one or more shaping techniques described with reference to FIGS. 2A-2C. In some examples, FIG. 3 may illustrate a transmission scheme for a PAS system implementing CB and TB sizes as described herein. Further, while the operations illustrated in FIG. 3, although shown in order, may be performed in any order, and may omit one or more operations, or include one or more additional operations.

For example, a wireless device, such as a transmitting device, may generate a TB at 305, and perform TB size determination at 310. In some examples, in a PAS system, the TB size may be a multiple of eight bits prior to any CRC addition. For example, the wireless device may determine the TB as a multiple of eight bits at 310 by padding bits of the generated TB to produce a quantity of bits 311. In some examples, such padding may involve padding the bits so the TB size is byte aligned when the TB size is not a multiple of eight. The wireless device may proceed to 315 using the TB size to determine and add TB CRC bits. In some examples, the TB size may be a multiple of eight bits for the quantity of bits 311 before CRC addition. Additionally, or alternatively, the TB size may be a multiple of eight bits including one or more CRC bits for bits 316.

In some examples, after TB segmentation into a set of CBs at 320 and outputting bits 321 (such as bits for a CB, bits for each of the CBs), an information CB size before shaping may be a multiple of eight. For example, the wireless device may perform CB shaping at 325 to shape one or more CBs of the set of CBs of the TB after TB segmentation, where each CB of the set of CBs may have a respective quantity of bits that is a multiple of eight bits. In some examples, the wireless device may perform the PAS operation per CB of the set of CBs of the TB, or for a subset of CBs (such as for one CB).

In some examples, a quantity of information bits to be shaped per CB as well as a quantity of unshaped information bits per CB may be a multiple of eight bits. For example, at 322, the wireless device may input the bits 321 into a demultiplexer. In some examples, the demultiplexer may output, for a CB of the set of CBs, a first quantity of unshaped bits 323 to be shaped (e.g., previously unshaped bits that are to be shaped) that may be a multiple of eight bits and a second quantity of unshaped bits 324 that may also be a multiple of eight bits. For example, each CB may include respective bits to be shaped and respective bits to remain unshaped. In some examples, the wireless device may input the unshaped bits 323 into the PAS operation at 325 to output shaped bits 326, while the unshaped bits 324 may remain unshaped. Additionally, or alternatively, a subset of CBs may each have bits to be shaped and bits to remain unshaped, while other CBs may include one of either bits to be shaped or bits to remain unshaped. In other examples, each CB may include one of either bits to be shaped or bits to remain unshaped.

At 327, the wireless device may add CB CRC. The wireless device may add CRC to one or more CBs (such as per CB) of the TB before CB shaping or after CB shaping. In some examples, if CRC is added before shaping (or other error detection bits are added) the quantity of bits of a CB of the set of CBs may be in accordance with a quantity of one or more CRC bits (or other error detection bits) generated before the performance of the PAS operation. For example, each information CB size that is a multiple of eight may include a corresponding CRC size within the total size. Further CRC may be added for any combination of CB subsets or CBs before and after shaping. Further, CRC may be added for shaped bits or unshaped bits, and may be added before or after demultiplexing into bits to be shaped and bits to remain unshaped.

At 330, the wireless device may perform encoding on the shaped bits 326 and the unshaped bits 324 to generate encoded information bits 335. For example, the wireless device may perform an FEC operation (or one or more FEC operations), where the encoded information bits 335 may be generated in accordance with performance of the FEC operation for the set of CBs after the performance of the PAS operation (or one or more PAS operations). In some examples, an FEC operation may involve utilizing LDPC code (such as LDPC encoding) as the FEC. The wireless device may in some examples perform rate matching, interleaving, CB concatenation, among other operations as described herein, after performing an FEC or LDPC encoding operation. Further, the wireless device may encode a single set of shaped bits, or a single set of unshaped bits for a CB.

In some examples, a quantity of shaped information bits (such as the shaped bits 326) per CB obtained (such as from a shaping module, from a distribution matcher) may be a multiple other than eight. In some examples, a quantity of unshaped information bits (such as the unshaped bits 323 to be shaped, the unshaped bits 324 to remain unshaped, or both) per CB may be a multiple other than eight. In some examples, for PAS, a quantity of shaped information bits may be based on a quantity of coded bits, such as encoded information bits 335, after channel encoding and rate matching. For example, the quantity of shaped bits may be multiples of a quantity of modulation symbols per CB. In some examples, the quantity of shaped information bits may be equal to a quantity of amplitude bits per CB. In some examples, when LDPC code is used as the FEC, an actual information size used by an LDPC encoder may be multiples of a lifting size (such as z) which may be a multiple of bits other than eight bits. In some examples, the quantity of unshaped bits 323 to be shaped, the quantity of unshaped bits 324, and the quantity of shaped bits 326 may be non-multiples of 8, while the sum of the unshaped bits 323 to be shaped and the unshaped bits 324 to remain unshaped may be a multiple of eight (for example, providing better memory access), and a sum of the shaped bits 326 and the unshaped bits 323 (such as the amount of bits input to the FEC) may also be a multiple of eight (such as to maintain backward compatibility). Additionally, or alternatively, any combination of multiples of eight and non-multiples of eight may be considered for CB size, TB size, and other quantities of information bits described herein.

For example, a CB size, including a CB size before and after shaping, may have an impact on the operation of shaping. For example, for CCDM and energy based shaping, a quantity of information bits prior to shaping may be determined by a shaping parameter v. In some examples, a native quantity of information bits resulting from a shaping parameter v may be a multiple other than eight bits. For example, for CCDM, a quantity of information bits prior to shaping may be determined by the parameter v in the Maxwell-Boltzmann distribution. In particular, from the v parameter, a transmitting or receiving device may infer the composition [n₁, n₂, . . . , nₘ], where each n of the composition may each represent a non-negative integer and a respective frequency of a respective modulation symbol. For example, n₁ may represent a frequency of occurrences of a modulation symbol 1 in a modulated message. In some examples, n₁+n₂+ . . . +nₘ=n, and n may denote a quantity of amplitude symbols after shaping. In some examples, the quantity of information bits for CCDM may be given by the multinomial function

$$floor ( {log}_{2} ( \begin{matrix}n \\ {n}_{1} , {n}_{2} , … , {n}_{m}\end{matrix} )$$

(which may represent the floor function of log₂ of (n choose n₁, n₂, . . . , nₘ)). As such, a quantity of information bits may be a multiple of eight bits or a multiple other than eight bits. Energy-based shaping may experience similar bit multiples, where a shaping parameter may be a total energy E of a set of sequences.

In some examples, an information CB size (such as prior to shaping) may be determined such that the information CB size is a multiple of eight bits. In some examples, a quantity of bits of a CB of the set of CBs may be in accordance with application of a floor function to an initial CB size that is associated with a shaping parameter. For example, to determine an information CB size prior to shaping at 325, for a given shaping parameter v (such as indicated in a grant for a communication), a wireless device may use the indicated parameter v to determine a first information CB size

$${K}_{info}^{initial} ,$$

which may be a multiple of eight bits or a multiple other than eight bits. The wireless device may utilize a largest integer that is a multiple of eight bits and that is smaller than or equal to

$${K}_{info , CB}^{intial} ( v )$$

as the information CB size, which may be denoted as K_{info,CB}. In some examples, this may be represented by Equation 1 below:

$${K}_{info , CB} = ⌊ {K}_{info , CB}^{initial} ( v ) / 8 ⌋ \cdot 8 \qquad ( 1 )$$

In some examples, a quantity of shaped bits for a CB of the set of CBs may be equal to a quantity of amplitude bits associated with the CB. For example, if a CRC is added prior to shaping, then K_{info,CB} may include the CRC size, as both the raw information bits and the CRC bits may be shaped. If CRC is inserted after the shaping (such as CB CRC), then the information CB size K_{info,CB} may exclude the CRC size. In some examples, the wireless device may obtain the shaping parameter as described with respect to FIGS. 2A-2C (such as from a grant received at, or output by, the wireless device).

In some examples, by utilizing the floor operation in Equation 1, the shaping may be guaranteed to be invertible at a receiving device side. For example, a ceiling or rounding function may result in the shaping being non-invertible, where in some examples two different sets of information bit sequences may map to (such as associate with) a same symbol sequence (such as a same shaped symbol sequence). In such an example, a receiving device side may be unable to determine which of the two options of different sets of information bit sequences is transmitted by a transmitting device.

In some examples, the wireless device may utilize an updated shaping parameter to compensate for rate loss. For example, the floor operation in Equation 1 may result in some rate losses for an actual information size by transmitting less information bits than what is supported by the shaping parameter (such as v in the case of CCDM). For example, after determining K_{info,CB} according to Equation 1 (such as using v), the wireless device (such as the transmitting device) may slightly modify (such as increase) the shaping parameter so that a maximum supported quantity of information bits is equal to K_{info,CB}. In the example of CCDM, the wireless device (such as transmitting device) may increase v to v′, so that a resulting quantity of information bits from the multi-nominal function is greater than or equal to K_{info,CB}. In some examples, both the transmitting device and receiving device may compute v′ and use v′ as the actual shaping parameter. In some examples, a downlink control information (DCI) message may indicate one or more bits for v or v′, such that a device may compute v′ with greater precision based on a v indicated in a DL or UL grant. Similarly, in case of energy based shaping, the wireless device may lower the energy parameter E used to determine the shaping procedure to E′, such that a maximum supported information size is equal to K_{info,CB}. In some examples, such operations may represent utilizing a first shaping parameter (v′ or E′) that is in accordance with an estimated quantity of bits (such as K_{info,CB}(v′)) resulting from application of the floor function to a second initial CB size (such as K_{info,CB}(v)) associated with a second shaping parameter (v or E).

In some examples, the total quantity of info bits per CB prior to shaping (this includes both info bits to be shaped, and info bits that will not be shaped) may be restricted to multiple of 8, and the total quantity of bits after shaping (including the shaped info bits and the unshaped info bits) per CB may be restricted to multiples of 8. However, the quantity of info bits to be shaped (for example, prior to shaping), the quantity of unshaped info bits, and the quantity of shaped info bits (output of the shaper) may not be restricted to multiples of 8.

After encoding and other operations performed at 330, the wireless device may transmit an encoded message including the encoded information bits 335, for example, in accordance with previously communicated scheduling information as described herein with respect to FIGS. 2A-2C. In some examples, the encoded message may be transmitted by the wireless device in accordance with one or more probabilistically-shaped QAM constellations.

In some examples, utilizing multiples of eight bits for unshaped bits (such as the bits 321 or the unshaped bits 323 or 324) may result in bits being byte-aligned, may enable the bits to be read out from memory (such as read CB by CB), and may improve efficiency for memory operations in bytes when each CB is in integer bytes. Utilizing a multiple of eight bits separately for the unshaped bits 323 and 324 may further improve efficiency in processing at a wireless device. For example, the unshaped bits 323 to be shaped and the unshaped bits 324 to remain unshaped may be read out (such as from the memory) at different times in pipelining, and so using eight bits may align the unshaped bits 323 and 324 by using byte increments without use of additional internal memory to store the unshaped information bits.

Additionally, or alternatively, implementing a floor function on a CB size based on a shaping parameter may enable byte alignment while enabling shaping to be invertible. Further, implementing an updated shaping parameter (such as v′) may remove rate loss due to flooring, and as a result, may result in a larger energy saving and improved spectral efficiency compared to using an originally indicated shaping parameter (such as v), while also enabling both a transmitting device and a receiving device side to compute a same v′ parameter to be aligned with a shaping composition. Performing similar operations for CB size calculation and new shaping parameter calculation for energy based shaping may also result in larger energy saving (such as shaping gain by using E′ instead of E).

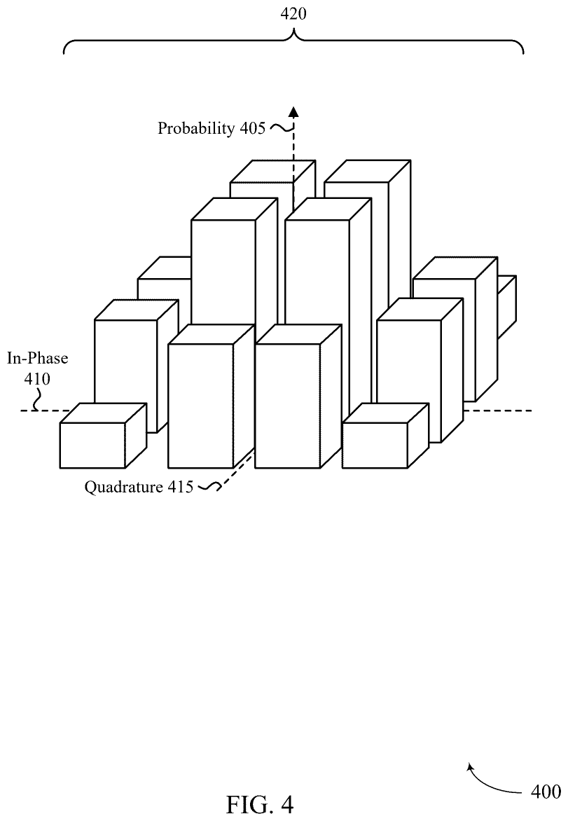

FIG. 4 shows an example of a modulation constellation with PAS 400 that supports information sizes for probabilistic shaping used in CBs and TBs for encoded messages in accordance with one or more aspects of the present disclosure. One or more of the techniques described herein with respect to FIGS. 1-3 may be performed in accordance with the modulation constellation 420 with PAS. A modulation constellation may be a set of points representing symbols (such as modulation symbols). For example, a signal may be modulated to produce one or more symbols. The symbols may differ from each other in phase, amplitude, or frequency. The modulation constellation may include a point for each symbol that may be transmitted. For instance, each point of the modulation constellation may be expressed in quadrature 415 and in-phase 410 dimensions. Examples of a modulation constellation may include a QAM (for example, 8 QAM, 16 QAM, 64 QAM, 256 QAM, or 1024 QAM, among other examples) constellation, a quadrature phase-shift keying (QPSK) constellation, an amplitude-shift keying (ASK) constellation, or a frequency-shift keying (FSK) constellation, among other examples. In some modulation constellations, some points may be located more closely to the origin than other points in a space with in-phase 410 and quadrature 415 dimensions. For instance, points that are relatively nearer to the origin may utilize relatively less energy or power for transmission, and points that are relatively further from the origin may utilize relatively more energy or power for transmission.

A non-uniform probabilistic distribution of a modulation constellation may be a distribution of points of a modulation constellation, where at least two points of the modulation constellation have different probabilities of being transmitted. In some non-uniform probabilistic distributions, points that are nearer to the origin (or points that utilize lower energy or power for transmission) may be transmitted more frequently or a may have a greater probability 405 of transmission than points that are further from the origin (or points that utilize higher energy or power for transmission), which may be transmitted less frequently or may have a lower probability 405 for transmission. For example, some modulation constellations may utilize the Maxwell-Boltzmann distribution, p(x)~e^{-v|x|}^{²}, where p(x) denotes the probability of transmitting a point x (for example, a 2N-dimensional modulation point with a transmission power or a distance of the point from the origin) and v is a shaping parameter (such as a shaping parameter as described herein with respect to FIGS. 1-4). Accordingly, the probability of transmitting a point may decrease as the transmission power or distance from the origin increases. As illustrated in the example of the modulation constellation 420 of FIG. 4, points that are nearer to the origin have a greater probability 405 of transmission than points that are further from the origin.

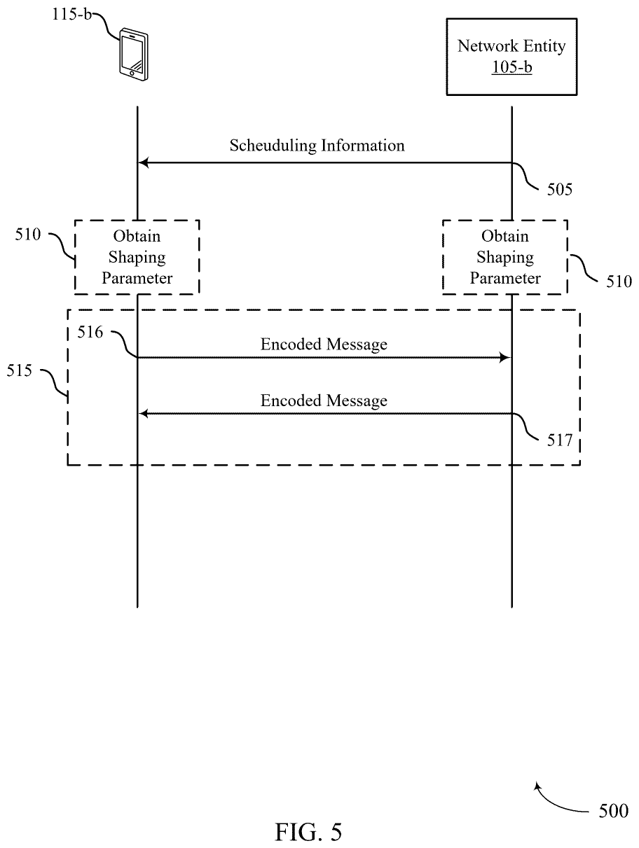

FIG. 5 shows an example of a process flow 500 that supports information sizes for probabilistic shaping used in CBs and TBs for encoded messages in accordance with one or more aspects of the present disclosure. The process flow includes one or more wireless communication devices, such as a UE 115-b and a network entity 105-b, which may be examples of UEs 115, network entities 105, or other wireless devices described herein with respect to FIGS. 1-3. In the following description of the process flow 500, the communications between the UE 115-b and the network entity 105-b may be transmitted in a different order than the example order shown, or the operations performed by the UE 115-b and the network entity 105-b may be performed in different orders or at different times. Some operations may also be omitted from the process flow 500, and other operations may be added to the process flow 500. Further, such operations may be performed between examples of other combinations of wireless devices (for example, between two UEs 115 in sidelink).

At 505, the UE 115-b and the network entity 105-b may communicate scheduling information for an encoded message.

In some examples, at 510, the UE 115-b, the network entity 105-b, or both, may obtain a shaping parameter.

At 515, the UE 115-b, the network entity 105-b, or both, may transmit the encoded message in accordance with the scheduling information. The encoded message may include a set of multiple bits that may be generated in accordance with performance of a PAS operation for a set of CBs of a TB, each CB of the set of CBs including a quantity of bits that is a multiple of eight bits.

In some examples, communicating the scheduling information may include receiving the scheduling information for an uplink transmission, and the encoded message that is transmitted in accordance with the scheduling information may be the uplink transmission. For example, the UE 115-b may receive, and the network entity 105-b may output (for example, transmit), an uplink grant at 505, and the UE 115-b may transmit, and the network entity 105-b may obtain (for example, receive), an uplink transmission, such as the encoded message, at 516. Additionally, or alternatively, communicating the scheduling information may include transmitting the scheduling information for a downlink transmission, and the encoded message that is transmitted in accordance with the scheduling information may be the downlink transmission. For example, the network entity 105-b may output, and the UE 115-b may receive, a downlink grant at 505, and the network entity 105-b may output, and the UE 115-b may receive, a downlink transmission, such as the encoded message, at 517.

In some examples, the quantity of bits of a CB of the set of CBs may be in accordance with application of a floor function to an initial CB size that is associated with the shaping parameter. Additionally, or alternatively, the shaping parameter may include a first shaping parameter that is in accordance with an estimated quantity of bits resulting from application of the floor function to a second initial CB size associated with a second shaping parameter. In some examples, communicating the scheduling information may include communicating the shaping parameter.

In some examples, the PAS operation may be performed per CB of the set of CBs of the TB. Further, the quantity of bits of a CB of the set of CBs may be in accordance with a quantity of one or more error detection bits generated before the performance of the PAS operation.

In some examples, a CB of the set of CBs may include a first quantity of unshaped bits that is a multiple of eight bits and a second quantity of unshaped bits that is a multiple of eight bits. In some examples, the first quantity of unshaped bits may be input into the PAS operation and the second quantity of unshaped bits may remain unshaped.

In some examples, the set of multiple bits may be generated in accordance with performance of an FEC operation for the set of CBs after the performance of the PAS operation. Additionally, or alternatively, a quantity of shaped bits for a CB of the set of CBs may be equal to a quantity of amplitude bits associated with the CB. Further, the TB may include a second quantity of bits that is a multiple of eight bits. In some examples, the encoded message may be transmitted in accordance with one or more probabilistically-shaped QAM constellations.

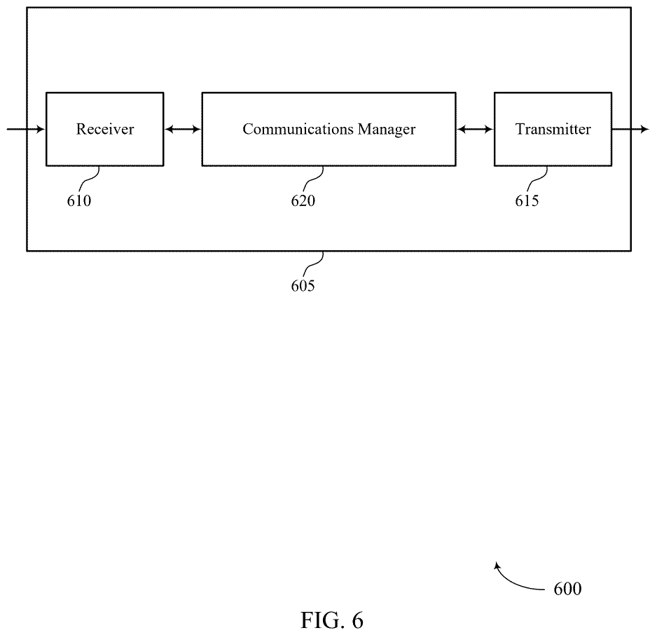

FIG. 6 shows a block diagram 600 of a device 605 that supports information sizes for probabilistic shaping used in CBs and TBs for encoded messages in accordance with one or more aspects of the present disclosure. The device 605 may be an example of aspects of a UE 115 or a network entity 105 as described herein. The device 605 may include a receiver 610, a transmitter 615, and a communications manager 620. The device 605, or one or more components of the device 605 (for example, the receiver 610, the transmitter 615, the communications manager 620), may include at least one processor, which may be coupled with at least one memory, to, individually or collectively, support or enable the described techniques. Each of these components may be in communication with one another (for example, via one or more buses).

The receiver 610 may provide a means for receiving information such as packets, user data, control information, or any combination thereof associated with various information channels (for example, control channels, data channels, information channels related to information sizes for probabilistic shaping). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (for example, control channels, data channels, information channels related to information sizes for probabilistic shaping). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of information sizes for probabilistic shaping as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (for example, in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (for example, by one or more processors, individually or collectively, executing instructions stored in the at least one memory).

Additionally, or alternatively, the communications manager 620, the receiver 610, the transmitter 615, or various combinations or components thereof may be implemented in code (for example, as communications management software or firmware) executed by at least one processor (for example, referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (for example, configured as or otherwise supporting, individually or collectively, a means for performing the functions described in the present disclosure).

In some examples, the communications manager 620 may be configured to perform various operations (for example, receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for communicating scheduling information for an encoded message. The communications manager 620 is capable of, configured to, or operable to support a means for transmitting the encoded message in accordance with the scheduling information, the encoded message including a set of multiple bits that are generated in accordance with performance of a PAS operation for a set of CBs of a TB, each CB of the set of CBs including a quantity of bits that is a multiple of eight bits.

By including or configuring the communications manager 620 in accordance with examples as described herein, the device 605 (for example, at least one processor controlling or otherwise coupled with the receiver 610, the transmitter 615, the communications manager 620, or a combination thereof) may support techniques for reduced processing, reduced power consumption, and more efficient utilization of communication resources by implementing multiples of eight bits for CB sizes and TB sizes before shaping, using a floor function, or updating a shaping parameter.

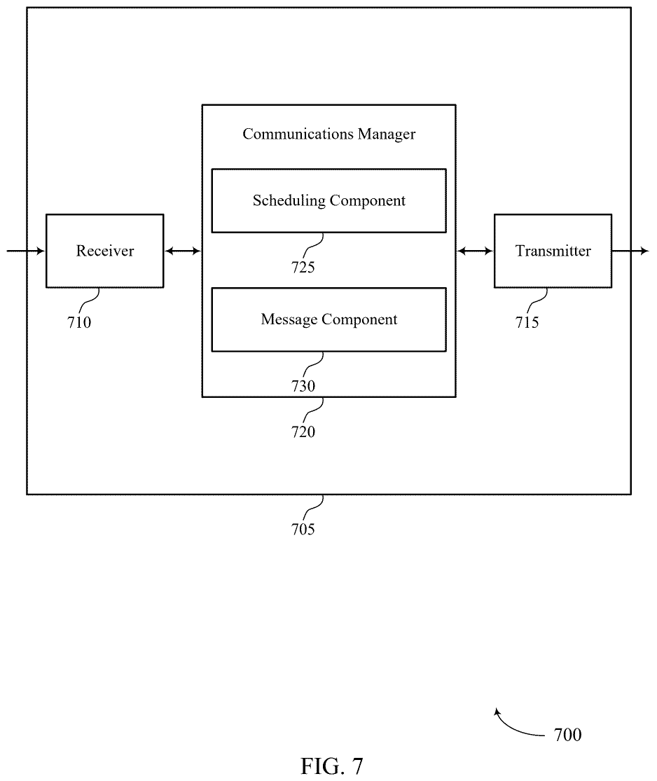

FIG. 7 shows a block diagram 700 of a device 705 that supports information sizes for probabilistic shaping used in CBs and TBs for encoded messages in accordance with one or more aspects of the present disclosure. The device 705 may be an example of aspects of a device 605, a UE 115, or a network entity 105 as described herein. The device 705 may include a receiver 710, a transmitter 715, and a communications manager 720. The device 705, or one or more components of the device 705 (for example, the receiver 710, the transmitter 715, the communications manager 720), may include at least one processor, which may be coupled with at least one memory, to support the described techniques. Each of these components may be in communication with one another (for example, via one or more buses).

The receiver 710 may provide a means for receiving information such as packets, user data, control information, or any combination thereof associated with various information channels (for example, control channels, data channels, information channels related to information sizes for probabilistic shaping). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (for example, control channels, data channels, information channels related to information sizes for probabilistic shaping). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of information sizes for probabilistic shaping as described herein. For example, the communications manager 720 may include a scheduling component 725 a message component 730, or any combination thereof. The communications manager 720 may be an example of aspects of a communications manager 620 as described herein. In some examples, the communications manager 720, or various components thereof, may be configured to perform various operations (for example, receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The scheduling component 725 is capable of, configured to, or operable to support a means for communicating scheduling information for an encoded message. The message component 730 is capable of, configured to, or operable to support a means for transmitting the encoded message in accordance with the scheduling information, the encoded message including a set of multiple bits that are generated in accordance with performance of a PAS operation for a set of CBs of a TB, each CB of the set of CBs including a quantity of bits that is a multiple of eight bits.

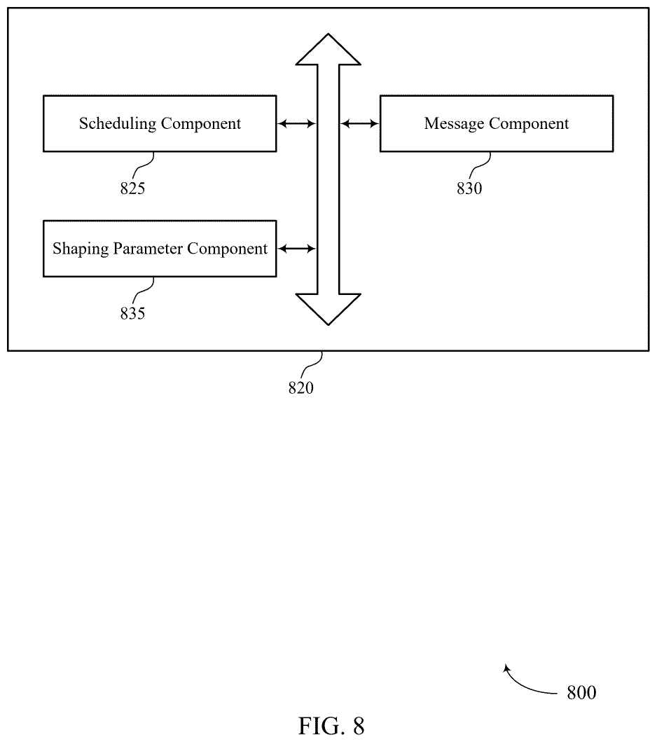

FIG. 8 shows a block diagram 800 of a communications manager 820 of a wireless device that supports information sizes for probabilistic shaping used in CBs and TBs for encoded messages in accordance with one or more aspects of the present disclosure. The communications manager 820 may be an example of aspects of a communications manager 620, a communications manager 720, or both, as described herein. The communications manager 820, or various components thereof, may be an example of means for performing various aspects of information sizes for probabilistic shaping as described herein. For example, the communications manager 820 may include a scheduling component 825, a message component 830, a shaping parameter component 835, or any combination thereof. Each of these components, or components or subcomponents thereof (for example, one or more processors, one or more memories), may communicate, directly or indirectly, with one another (for example, via one or more buses). The communications may include communications within a protocol layer of a protocol stack, communications associated with a logical channel of a protocol stack (for example, between protocol layers of a protocol stack, within a device, component, or virtualized component associated with a network entity 105, between devices, components, or virtualized components associated with a network entity 105), or any combination thereof.

The communications manager 820 may support wireless communications in accordance with examples as disclosed herein. The scheduling component 825 is capable of, configured to, or operable to support a means for communicating scheduling information for an encoded message. The message component 830 is capable of, configured to, or operable to support a means for transmitting the encoded message in accordance with the scheduling information, the encoded message including a set of multiple bits that are generated in accordance with performance of a PAS operation for a set of CBs of a TB, each CB of the set of CBs including a quantity of bits that is a multiple of eight bits.

In some examples, the shaping parameter component 835 is capable of, configured to, or operable to support a means for obtaining a shaping parameter, the quantity of bits of a CB of the set of CBs being in accordance with application of a floor function to an initial CB size that is associated with the shaping parameter.

In some examples, the shaping parameter includes a first shaping parameter that is in accordance with an estimated quantity of bits resulting from application of the floor function to a second initial CB size associated with a second shaping parameter.

In some examples, to support communicating the scheduling information, the shaping parameter component 835 is capable of, configured to, or operable to support a means for communicating the shaping parameter.

In some examples, the PAS operation is performed per CB of the set of CBs of the TB.

In some examples, the quantity of bits of a CB of the set of CBs is in accordance with a quantity of one or more error detection bits generated before the performance of the PAS operation.

In some examples, a CB of the set of CBs includes a first quantity of unshaped bits that is a multiple of eight bits and a second quantity of unshaped bits that is a multiple of eight bits. In some examples, the first quantity of unshaped bits are input into the PAS operation and the second quantity of unshaped bits remain unshaped.

In some examples, the set of multiple bits are generated in accordance with performance of an FEC operation for the set of CBs after the performance of the PAS operation.

In some examples, a quantity of shaped bits for a CB of the set of CBs is equal to a quantity of amplitude bits associated with the CB.

In some examples, the TB includes a second quantity of bits that is a multiple of eight bits.

In some examples, the encoded message is transmitted in accordance with one or more probabilistically-shaped QAM constellations.

In some examples, to support communicating the scheduling information, the scheduling component 825 is capable of, configured to, or operable to support a means for receiving the scheduling information for an uplink transmission, the encoded message that is transmitted in accordance with the scheduling information being the uplink transmission.

In some examples, to support communicating the scheduling information, the scheduling component 825 is capable of, configured to, or operable to support a means for transmitting the scheduling information for a downlink transmission, the encoded message that is transmitted in accordance with the scheduling information being the downlink transmission.

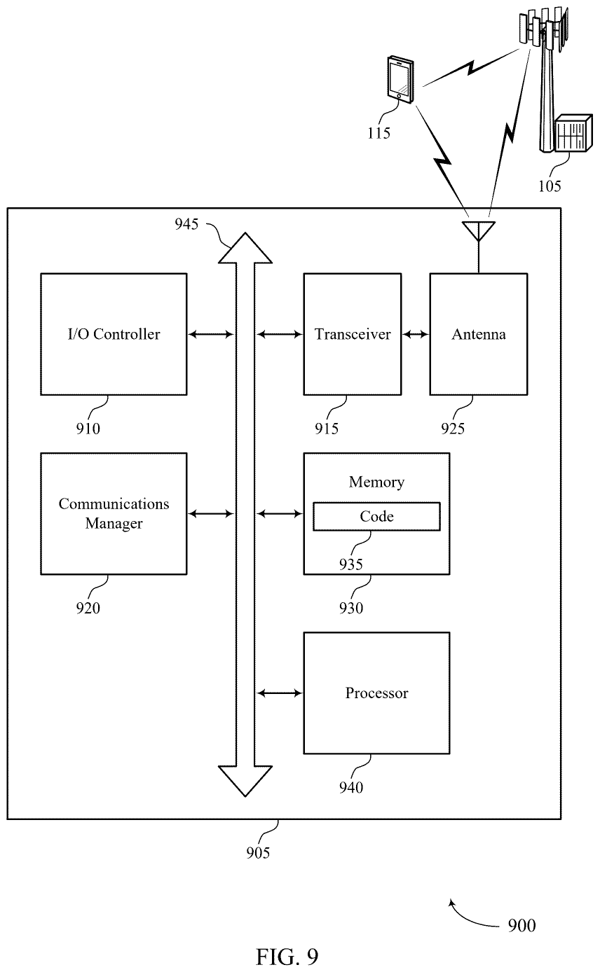

FIG. 9 shows a diagram of a system 900 including a device 905 that supports information sizes for probabilistic shaping used in CBs and TBs for encoded messages in accordance with one or more aspects of the present disclosure. The device 905 may be an example of or include components of a device 605, a device 705, or a UE 115 as described herein. The device 905 may communicate (for example, wirelessly) with one or more other devices (for example, network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (for example, operatively, communicatively, functionally, electronically, electrically) via one or more buses (for example, a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (for example, when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (for example, one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (for example, the at least one memory 930) to cause the device 905 to perform various functions (for example, functions or tasks supporting information sizes for probabilistic shaping). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (for example, processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for communicating scheduling information for an encoded message. The communications manager 920 is capable of, configured to, or operable to support a means for transmitting the encoded message in accordance with the scheduling information, the encoded message including a set of multiple bits that are generated in accordance with performance of a PAS operation for a set of CBs of a TB, each CB of the set of CBs including a quantity of bits that is a multiple of eight bits.

By including or configuring the communications manager 920 in accordance with examples as described herein, the device 905 may support techniques for improved communication reliability, reduced latency, improved user experience related to reduced processing, reduced power consumption, more efficient utilization of communication resources, longer battery life, and improved utilization of processing capability by implementing multiples of eight bits for CB sizes and TB sizes before shaping, using a floor function, or updating a shaping parameter.

In some examples, the communications manager 920 may be configured to perform various operations (for example, receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of information sizes for probabilistic shaping as described herein, or the at least one processor 940 and the at least one memory 930 may be otherwise configured to, individually or collectively, perform or support such operations.

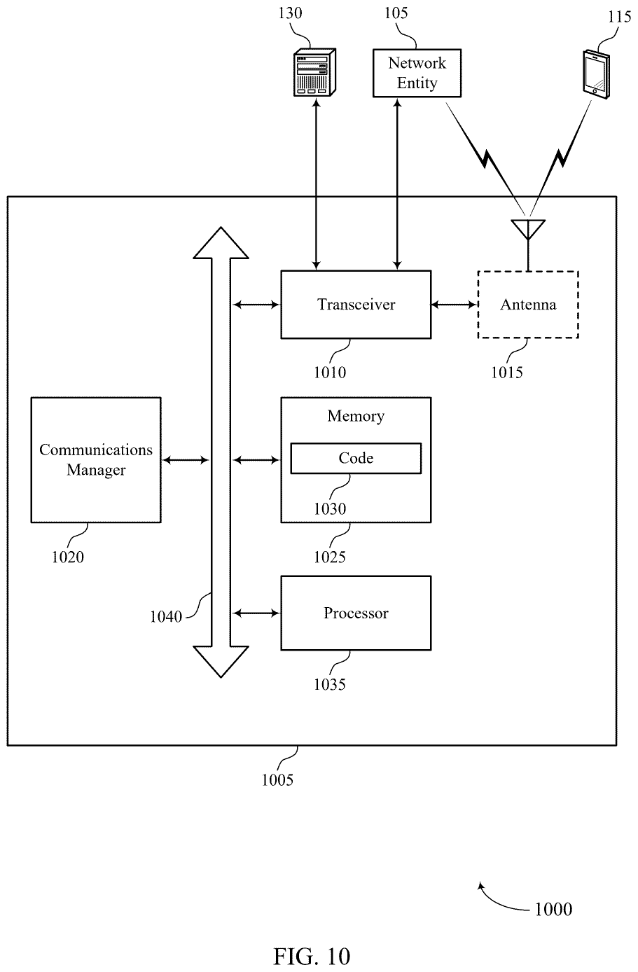

FIG. 10 shows a diagram of a system 1000 including a device 1005 that supports information sizes for probabilistic shaping used in CBs and TBs for encoded messages in accordance with one or more aspects of the present disclosure. The device 1005 may be an example of or include components of a device 605, a device 705, or a network entity 105 as described herein. The device 1005 may communicate with other network devices or network equipment such as one or more of the network entities 105, UEs 115, or any combination thereof. The communications may include communications over one or more wired interfaces, over one or more wireless interfaces, or any combination thereof. The device 1005 may include components that support outputting and obtaining communications, such as a communications manager 1020, a transceiver 1010, one or more antennas 1015, at least one memory 1025, code 1030, and at least one processor 1035. These components may be in electronic communication or otherwise coupled (for example, operatively, communicatively, functionally, electronically, electrically) via one or more buses (for example, a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (for example, concurrently). The transceiver 1010 may also include a modem to modulate signals, to provide the modulated signals for transmission (for example, by one or more antennas 1015, by a wired transmitter), to receive modulated signals (for example, from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or one or more memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or one or more memory components (for example, the at least one processor 1035, the at least one memory 1025, or both), may be included in a chip or chip assembly that is installed in the device 1005. In some examples, the transceiver 1010 may be operable to support communications via one or more communications links (for example, communication link(s) 125, backhaul communication link(s) 120, a midhaul communication link 162, a fronthaul communication link 168).

The at least one memory 1025 may include RAM, ROM, or any combination thereof. The at least one memory 1025 may store computer-readable, computer-executable, or processor-executable code, such as the code 1030. The code 1030 may include instructions that, when executed by one or more of the at least one processor 1035, cause the device 1005 to perform various functions described herein. The code 1030 may be stored in a non-transitory computer-readable medium such as system memory or another type of memory. In some cases, the code 1030 may not be directly executable by a processor of the at least one processor 1035 but may cause a computer (for example, when compiled and executed) to perform functions described herein. In some cases, the at least one memory 1025 may include, among other things, a BIOS which may control basic hardware or software operation such as the interaction with peripheral components or devices. In some examples, the at least one processor 1035 may include multiple processors and the at least one memory 1025 may include multiple memories. One or more of the multiple processors may be coupled with one or more of the multiple memories which may, individually or collectively, be configured to perform various functions herein (for example, as part of a processing system).

The at least one processor 1035 may include one or more intelligent hardware devices (for example, one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1035 may be configured to operate a memory array using a memory controller. In some other cases, a memory controller may be integrated into one or more of the at least one processor 1035. The at least one processor 1035 may be configured to execute computer-readable instructions stored in a memory (for example, one or more of the at least one memory 1025) to cause the device 1005 to perform various functions (for example, functions or tasks supporting information sizes for probabilistic shaping). For example, the device 1005 or a component of the device 1005 may include at least one processor 1035 and at least one memory 1025 coupled with one or more of the at least one processor 1035, the at least one processor 1035 and the at least one memory 1025 configured to perform various functions described herein. The at least one processor 1035 may be an example of a cloud-computing platform (for example, one or more physical nodes and supporting software such as operating systems, virtual machines, or container instances) that may host the functions (for example, by executing code 1030) to perform the functions of the device 1005. The at least one processor 1035 may be any one or more suitable processors capable of executing scripts or instructions of one or more software programs stored in the device 1005 (such as within one or more of the at least one memory 1025).

In some examples, the at least one processor 1035 may include multiple processors and the at least one memory 1025 may include multiple memories. One or more of the multiple processors may be coupled with one or more of the multiple memories, which may, individually or collectively, be configured to perform various functions herein. In some examples, the at least one processor 1035 may be a component of a processing system, which may refer to a system (such as a series) of machines, circuitry (including, for example, one or both of processor circuitry (which may include the at least one processor 1035) and memory circuitry (which may include the at least one memory 1025)), or components, that receives or obtains inputs and processes the inputs to produce, generate, or obtain a set of outputs. The processing system may be configured to perform one or more of the functions described herein. For example, the at least one processor 1035 or a processing system including the at least one processor 1035 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1025 or otherwise, to perform one or more of the functions described herein.

In some examples, a bus 1040 may support communications of (for example, within) a protocol layer of a protocol stack. In some examples, a bus 1040 may support communications associated with a logical channel of a protocol stack (for example, between protocol layers of a protocol stack), which may include communications performed within a component of the device 1005, or between different components of the device 1005 that may be co-located or located in different locations (for example, where the device 1005 may refer to a system in which one or more of the communications manager 1020, the transceiver 1010, the at least one memory 1025, the code 1030, and the at least one processor 1035 may be located in one of the different components or divided between different components).

In some examples, the communications manager 1020 may manage aspects of communications with a core network 130 (for example, via one or more wired or wireless backhaul links). For example, the communications manager 1020 may manage the transfer of data communications for client devices, such as one or more UEs 115. In some examples, the communications manager 1020 may manage communications with one or more other network entities 105, and may include a controller or scheduler for controlling communications with UEs 115 (for example, in cooperation with the one or more other network devices). In some examples, the communications manager 1020 may support an X2 interface within an LTE/LTE-A wireless communications network technology to provide communication between network entities 105.

The communications manager 1020 may support wireless communications in accordance with examples as disclosed herein. For example, the communications manager 1020 is capable of, configured to, or operable to support a means for communicating scheduling information for an encoded message. The communications manager 1020 is capable of, configured to, or operable to support a means for transmitting the encoded message in accordance with the scheduling information, the encoded message including a set of multiple bits that are generated in accordance with performance of a PAS operation for a set of CBs of a TB, each CB of the set of CBs including a quantity of bits that is a multiple of eight bits.

By including or configuring the communications manager 1020 in accordance with examples as described herein, the device 1005 may support techniques for improved communication reliability, reduced latency, improved user experience related to reduced processing, reduced power consumption, more efficient utilization of communication resources, longer battery life, and improved utilization of processing capability by implementing multiples of eight bits for CB sizes and TB sizes before shaping, using a floor function, or updating a shaping parameter.

In some examples, the communications manager 1020 may be configured to perform various operations (for example, receiving, obtaining, monitoring, outputting, transmitting) using or otherwise in cooperation with the transceiver 1010, the one or more antennas 1015 (for example, where applicable), or any combination thereof. Although the communications manager 1020 is illustrated as a separate component, in some examples, one or more functions described with reference to the communications manager 1020 may be supported by or performed by the transceiver 1010, one or more of the at least one processor 1035, one or more of the at least one memory 1025, the code 1030, or any combination thereof (for example, by a processing system including at least a portion of the at least one processor 1035, the at least one memory 1025, the code 1030, or any combination thereof). For example, the code 1030 may include instructions executable by one or more of the at least one processor 1035 to cause the device 1005 to perform various aspects of information sizes for probabilistic shaping as described herein, or the at least one processor 1035 and the at least one memory 1025 may be otherwise configured to, individually or collectively, perform or support such operations.

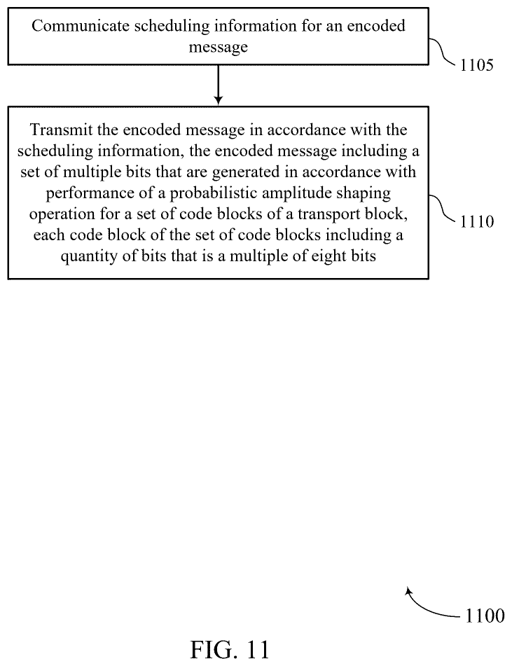

FIG. 11 shows a flowchart illustrating a method 1100 that supports information sizes for probabilistic shaping in accordance with one or more aspects of the present disclosure. The operations of the method 1100 may be implemented by a UE or a network entity or its components as described herein. For example, the operations of the method 1100 may be performed by a UE 115 or a network entity as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1105, the method may include communicating scheduling information for an encoded message. The operations of 1105 may be performed in accordance with examples as disclosed herein. In some examples, aspects of the operations of 1105 may be performed by a scheduling component 825 as described with reference to FIG. 8.

At 1110, the method may include transmitting the encoded message in accordance with the scheduling information, the encoded message including a set of multiple bits that are generated in accordance with performance of a PAS operation for a set of CBs of a TB, each CB of the set of CBs including a quantity of bits that is a multiple of eight bits. The operations of 1110 may be performed in accordance with examples as disclosed herein. In some examples, aspects of the operations of 1110 may be performed by a message component 830 as described with reference to FIG. 8.

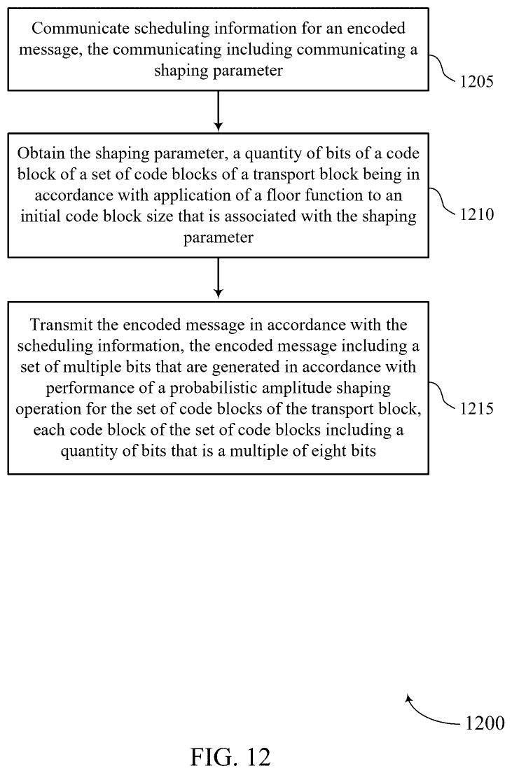

FIG. 12 shows a flowchart illustrating a method 1200 that supports information sizes for probabilistic shaping in accordance with one or more aspects of the present disclosure. The operations of the method 1200 may be implemented by a UE or a network entity or its components as described herein. For example, the operations of the method 1200 may be performed by a UE 115 or a network entity as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1205, the method may include communicating scheduling information for an encoded message, the communicating including communicating a shaping parameter. The operations of 1205 may be performed in accordance with examples as disclosed herein. In some examples, aspects of the operations of 1205 may be performed by a scheduling component 825 as described with reference to FIG. 8. In some examples, aspects of the operations of 1215 may be performed by a shaping parameter component 835 as described with reference to FIG. 8.

At 1210, the method may include obtaining the shaping parameter, a quantity of bits of a CB of a set of CBs of a TB being in accordance with application of a floor function to an initial CB size that is associated with the shaping parameter. The operations of 1210 may be performed in accordance with examples as disclosed herein. In some examples, aspects of the operations of 1210 may be performed by a shaping parameter component 835 as described with reference to FIG. 8.

At 1215, the method may include transmitting the encoded message in accordance with the scheduling information, the encoded message including a set of multiple bits that are generated in accordance with performance of a PAS operation for the set of CBs of the TB, each CB of the set of CBs including a quantity of bits that is a multiple of eight bits. The operations of 1215 may be performed in accordance with examples as disclosed herein. In some examples, aspects of the operations of 1215 may be performed by a message component 830 as described with reference to FIG. 8.

The following provides an overview of aspects of the present disclosure:

Aspect 1: A method for wireless communications at a wireless communication device, comprising: communicating scheduling information for an encoded message; and transmitting the encoded message in accordance with the scheduling information, the encoded message comprising a plurality of bits that are generated in accordance with performance of a PAS operation for a set of CBs of a TB, each CB of the set of CBs comprising a quantity of bits that is a multiple of eight bits.

Aspect 2: The method of aspect 1, further comprising obtaining a shaping parameter, the quantity of bits of a CB of the set of CBs being in accordance with application of a floor function to an initial CB size that is associated with the shaping parameter.

Aspect 3: The method of aspect 2, wherein the shaping parameter comprises a first shaping parameter that is in accordance with an estimated quantity of bits resulting from application of the floor function to a second initial CB size associated with a second shaping parameter.

Aspect 4: The method of any of aspects 2 through 3, wherein communicating the scheduling information comprises communicating the shaping parameter.

Aspect 5: The method of any of aspects 1 through 4, wherein the PAS operation is performed per CB of the set of CBs of the TB.

Aspect 6: The method of any of aspects 1 through 5, wherein the quantity of bits of a CB of the set of CBs is in accordance with a quantity of one or more error detection bits generated before the performance of the PAS operation.

Aspect 7: The method of any of aspects 1 through 6, wherein: a CB of the set of CBs comprises a first quantity of unshaped bits that is a multiple of eight bits and a second quantity of unshaped bits that is a multiple of eight bits, and the first quantity of unshaped bits are input into the PAS operation and the second quantity of unshaped bits remain unshaped.

Aspect 8: The method of any of aspects 1 through 7, wherein the plurality of bits are generated in accordance with performance of an FEC operation for the set of CBs after the performance of the PAS operation.

Aspect 9: The method of aspect 8, wherein a quantity of shaped bits for a CB of the set of CBs is equal to a quantity of amplitude bits associated with the CB.

Aspect 10: The method of any of aspects 1 through 9, wherein the TB comprises a second quantity of bits that is a multiple of eight bits.

Aspect 11: The method of any of aspects 1 through 10, wherein the encoded message is transmitted in accordance with one or more probabilistically-shaped QAM constellations.

Aspect 12: The method of any of aspects 1 through 11, wherein communicating the scheduling information comprises receiving the scheduling information for an uplink transmission, the encoded message that is transmitted in accordance with the scheduling information being the uplink transmission.

Aspect 13: The method of any of aspects 1 through 11, wherein communicating the scheduling information comprises transmitting the scheduling information for a downlink transmission, the encoded message that is transmitted in accordance with the scheduling information being the downlink transmission.

Aspect 14: A wireless communication device for wireless communications, comprising one or more memories storing processor-executable code, and one or more processors coupled with the one or more memories and individually or collectively operable to execute the code to cause the wireless communication device to perform a method of any of aspects 1 through 13.

Aspect 15: An apparatus for wireless communication at a wireless communication device, comprising a processing system that includes processor circuitry and memory circuitry that stores code, the processing system configured to cause the apparatus to perform a method of any of aspects 1 through 13.

Aspect 16: A wireless communication device for wireless communications, comprising at least one means for performing a method of any of aspects 1 through 13.

Aspect 17: A non-transitory computer-readable medium storing code for wireless communications, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations. In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (for example, receiving information), accessing (for example, accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a wireless communication device, comprising:
a processing system that includes processor circuitry and memory circuitry that stores code, the processing system configured to cause the apparatus to:
communicate scheduling information for an encoded message; and
transmit the encoded message in accordance with the scheduling information, the encoded message comprising a plurality of bits that are generated in accordance with performance of a probabilistic amplitude shaping operation for a set of code blocks of a transport block, each code block of the set of code blocks comprising a quantity of bits that is a multiple of eight bits.

2. The apparatus of claim 1, wherein the processing system is further configured to cause the apparatus to obtain a shaping parameter, the quantity of bits of a code block of the set of code blocks being in accordance with application of a floor function to an initial code block size that is associated with the shaping parameter.

3. The apparatus of claim 2, wherein the shaping parameter comprises a first shaping parameter that is in accordance with an estimated quantity of bits resulting from application of the floor function to a second initial code block size associated with a second shaping parameter.

4. The apparatus of claim 2, wherein, to communicate the scheduling information, the processing system is configured to cause the apparatus to communicate the shaping parameter.

5. The apparatus of claim 1, wherein the probabilistic amplitude shaping operation is performed per code block of the set of code blocks of the transport block.

6. The apparatus of claim 1, wherein the quantity of bits of a code block of the set of code blocks is in accordance with a quantity of one or more error detection bits generated before the performance of the probabilistic amplitude shaping operation.

7. The apparatus of claim 1, wherein:
a code block of the set of code blocks comprises a first quantity of unshaped bits that is a multiple of eight bits and a second quantity of unshaped bits that is a multiple of eight bits, and
the first quantity of unshaped bits are input into the probabilistic amplitude shaping operation and the second quantity of unshaped bits remain unshaped.

8. The apparatus of claim 1, wherein the plurality of bits are generated in accordance with performance of a forward error correction operation for the set of code blocks after the performance of the probabilistic amplitude shaping operation.

9. The apparatus of claim 8, wherein a quantity of shaped bits for a code block of the set of code blocks is equal to a quantity of amplitude bits associated with the code block.

10. The apparatus of claim 1, wherein the transport block comprises a second quantity of bits that is a multiple of eight bits.

11. The apparatus of claim 1, wherein the encoded message is transmitted in accordance with one or more probabilistically-shaped quadrature amplitude modulation (QAM) constellations.

12. The apparatus of claim 1, wherein, to communicate the scheduling information, the processing system is configured to cause the apparatus to receive the scheduling information for an uplink transmission, the encoded message that is transmitted in accordance with the scheduling information being the uplink transmission.

13. The apparatus of claim 1, wherein, to communicate the scheduling information, the processing system is configured to cause the apparatus to transmit the scheduling information for a downlink transmission, the encoded message that is transmitted in accordance with the scheduling information being the downlink transmission.

14. A method for wireless communication at a wireless communication device, comprising:
communicating scheduling information for an encoded message; and
transmitting the encoded message in accordance with the scheduling information, the encoded message comprising a plurality of bits that are generated in accordance with performance of a probabilistic amplitude shaping operation for a set of code blocks of a transport block, each code block of the set of code blocks comprising a quantity of bits that is a multiple of eight bits.

15. The method of claim 14, further comprising obtaining a shaping parameter, the quantity of bits of a code block of the set of code blocks being in accordance with application of a floor function to an initial code block size that is associated with the shaping parameter.

16. The method of claim 15, wherein the shaping parameter comprises a first shaping parameter that is in accordance with an estimated quantity of bits resulting from application of the floor function to a second initial code block size associated with a second shaping parameter.

17. The method of claim 15, wherein communicating the scheduling information comprises communicating the shaping parameter.

18. The method of claim 14, wherein the probabilistic amplitude shaping operation is performed per code block of the set of code blocks of the transport block.

19. A non-transitory computer-readable medium storing code for wireless communications, the code comprising instructions executable by one or more processors to:
communicate scheduling information for an encoded message; and
transmit the encoded message in accordance with the scheduling information, the encoded message comprising a plurality of bits that are generated in accordance with performance of a probabilistic amplitude shaping operation for a set of code blocks of a transport block, each code block of the set of code blocks comprising a quantity of bits that is a multiple of eight bits.

20. The non-transitory computer-readable medium of claim 19, wherein the instructions are further executable by the one or more processors to obtain a shaping parameter, the quantity of bits of a code block of the set of code blocks being in accordance with application of a floor function to an initial code block size that is associated with the shaping parameter.
